(19) United States
(12) Patent Application Publication
(10) Pub. No.: US 2014/0158851 A1
(43) Pub. Date: Jun. 12, 2014

(54) Clamp

(71) Applicant: MONKEY ARMZ, LLC, Laingsburg, MI (US)

(72) Inventor: Linda Cay MUMMAW, Laingsburg, MI (US)

(73) Assignee: MONKEY ARMZ, LLC, Laingsburg, MI (US)

(21) Appl. No.: 13/793,149

(22) Filed: Mar. 11, 2013

Related U.S. Application Data
(60) Provisional application No. 61/734,041, filed on Dec. 6, 2012.

(51) Int. Cl. F16M 13/02

(52) U.S. Cl. CPC F16M 13/02
USPC 248/342

(57) ABSTRACT

A hanger clip assembly for use in releasably securing an article to a support structure includes a clip unit and a resilient cord unit. The clip unit is a clamp assembly configured to releasably secure the article to the hanger clip assembly. The cord unit defines a closed loop that extends from the clip unit and permits the hanger clip assembly to be releasably secured to any existing support structure.

### CROSS-REFERENCE TO RELATED APPLICATION

This application claims the benefit of U.S. Provisional Application No. 61/734,041, filed on Dec. 6, 2012. The entire disclosure of the above application is incorporated herein by reference.

### FIELD

The present disclosure relates generally to hanging devices and, more particularly, to a hanger clip assembly having a clip unit and an elastic cord unit configured to define a versatile, easy-to-use portable hanging device.

### BACKGROUND

This section provides background information related to the present disclosure which is not necessarily prior art.

Resilient clips, commonly referred to as spring clips, are available in various configurations for use in hanging articles from a support structure. For example, articles of clothing are releasably secured by such spring clips to a clothes line or support rod for air drying. Exemplary spring clips are shown in U.S. Pat. Nos. 4,878,276, 5,075,935 and 5,402,558.

In view of increased consumer demand for inexpensive, yet versatile convenience items, a need exists to develop an improved spring clip for use as a portable hanging device.

### SUMMARY

This section provides a general summary of the disclosure, and is not a comprehensive disclosure of its full scope or all of its features and advantages.

In accordance with one aspect of the present disclosure, a hanger clip assembly for use in securing an article to an existing structure is disclosed. The hanger clip assembly is fabricated to include a clip unit and an elastic cord unit assembled to define a versatile, easy-to-use portable hanging device. The clip unit and the cord unit are made independent and can be assembled together to provide a two-piece portable hanging device. Once assembled, the cord unit defines a closed loop that extends from the clip unit and which can be used to releasably secure the portable hanging device to any existing structure. The existing structure can include, without limitation and for exemplary purposes only, a tree branch, a deck rail, a door handle, a piece of furniture and the like.

Further areas of applicability will become apparent from the description provided herein. The description and specific examples in this summary are intended for purposes of explanation only and are not intended to limit the scope of the present disclosure. Additional benefits and advantages of the present disclosure will become apparent to those skilled in the art to which this invention relates from reading the following detailed description and the appended claims, taken in conjunction with the accompanying drawings.

### DRAWINGS

The drawings described herein are for illustrative purposes only of a selected embodiment and not all possible implementation, and the drawings are not intended to limit the scope of the present disclosure.

FIG. 1 is a perspective view of a hanger clip assembly constructed in accordance with the teachings of the present disclosure and generally including a clip unit and a cord unit;

FIG. 2 is an enlarged partial view of the hanger clip assembly of FIG. 1 illustrating the clip unit in greater detail;

FIG. 3 is a side view of the clip unit;

FIG. 4 is an end view of the clip unit;

FIG. 5 is an exploded perspective view of the clip unit shown in FIGS. 3 and 4;

FIG. 6 is a view of the cord unit; and

FIG. 7 is an environmental view illustrating use of a pair of hanger clip assemblies for suspending an article of clothing from a railing.

Corresponding reference numerals indicate corresponding parts throughout the several views of the drawings.

### DETAILED DESCRIPTION

Example embodiments will now be described more fully with reference to the accompanying drawings.

The exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

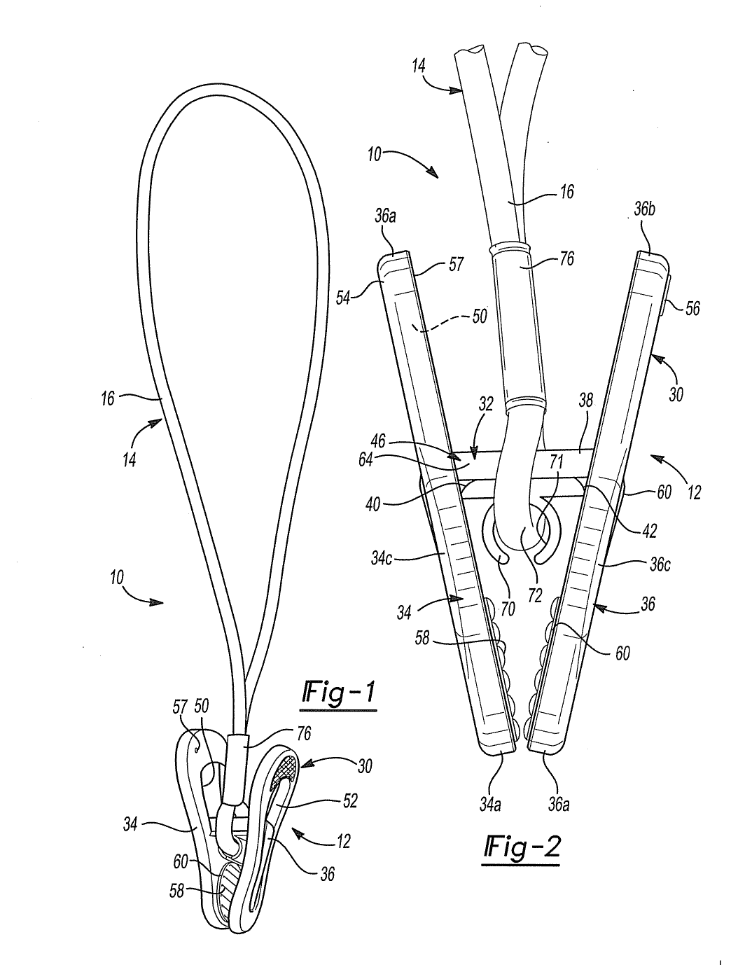

Referring primarily to FIG. 1, a hanger clip assembly 10 constructed in accordance with the teachings of the present disclosure is shown to generally include a clip unit 12 and a cord unit 14. In its most basic application, clip unit 12 is configured and arranged to permit an “article” to be releasably clamped. As will be detailed, clip unit 12 is operable in either of a clamped mode or a released mode for permitting such an article to be releasably clamped. In addition, cord unit 14 is attached to clip unit 12 and is configured and arranged to define a closed loop 16. Closed loop 16 is adapted to permit cord unit 14 to be releasably attached to a “support” structure. In accordance with one exemplary environmental use of the present invention, FIG. 7 illustrates a pair of hanger clip assemblies 10 that have clip units 12 releasably clamped to an article of clothing 18 and have cord units 14 releasably attached to a support structure shown as a deck rail 20. Those skilled in the art will appreciate that clothing 18 is only intended to be an example of an article that can be releasably clamped by clip unit 12 and that deck rail 20 is only intended to be an example of a support structure to which cord unit 14 can be releasably attached.

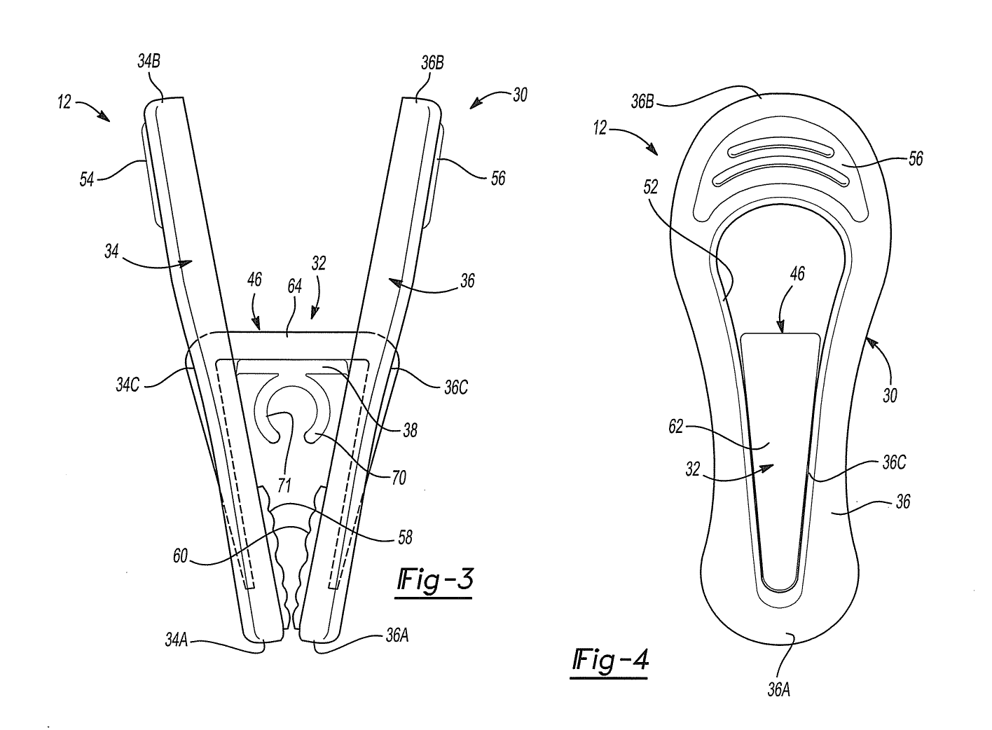

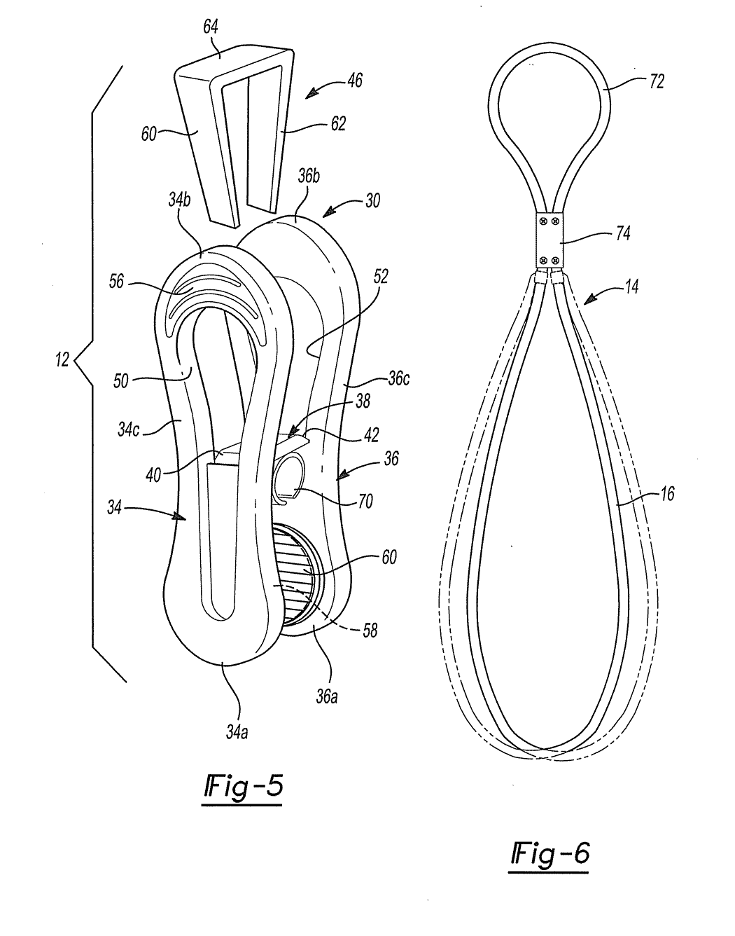

With particular reference now to FIGS. 2 through 5, an exemplary construction for clip unit 12 will be described in greater detail. Clip unit 12 may include a clamp assembly 30 and a biasing member 32. Clamp assembly 30 can include a pair of facing and complementary clamp members 34 and 36 that are interconnected via a bridge member 38. In particular, clamp members 34 and 36 are connected to bridge member 38 by a pair of living hinges 40 and 42. Biasing member 32 is generally C-shaped spring bracket 46 that is configured and arranged to be mounted over bridge member 38 and between clamp members 34, 36 to normally bias clamp end portions 34A, 36A of clamp members 34, 36 toward an engaged position. When clamp members 34, 36 are located in the engaged position shown, due to the biasing applied thereto by spring bracket 46, clip unit 12 is defined to be functioning in a closed or “clamped” mode. In this mode, handle end portions 34B, 36B of clamp members 34, 36 are biased by biasing member 32 to a position displaced from each other. An inward force applied to handle portions 34B, 36B by the user functions to overcome the biasing force applied by spring bracket 46 and cause the clamp members 34, 36 to move to an open or released position whereat clamp end portions 34A, 36A are displace. With clamp members 34, 36 in the released position, clip unit 12 is defined to be functioning in an open or “released” mode.

With continued reference to FIGS. 2 through 5 of the drawings, the enlarged handle portions 34B, 36B of clamp members 34, 36 are generally loop-shaped and include an opening 50,52. Openings 50, 52 are dimensioned to enable a user's fingers to be comfortably received therein. Finger pads 54, 56 are provided between the terminal ends of handle portions 34B, 36B and openings 50, 52 to provide the user with a frictional gripping surface to facilitate opening of clip unit 12 for moving it from its closed position into its released position. Finger pads 54, 56 can be adhesive attached to outer surfaces of clamp members 34, 36 or can be mounted via an attachment pin 57 mounted in a throughbore.

Gripper pads 58, 60 are provided between the facing surfaces of clamp end portions 34A, 36A of clamp members 34, 36 and provide ridges or other indentations/projections that are adapted to engage and hold an article (i.e., a garment) therebetween under the biasing force applied thereto by spring bracket 46. Intermediate portions 34C, 36C of clamp members 34, 36 include a planar recess configured to be engaged by resilient legs 60, 62 of spring bracket 46. Legs 60, 62 are interconnected by a transverse flange 64 which is dimensioned to extend over and engage bridge member 38 of clip 30. The upper ends of intermediate portions 34C, 36C are joined at opposite ends of bridge member 38 via living hinges 40, 42. In addition, a cylindrical housing 70 defining an arcuate recess 71, which is suitably configured to receive a first end portion 72 of cord unit 14, is formed at or attached to the underside surface of bridge member 38.

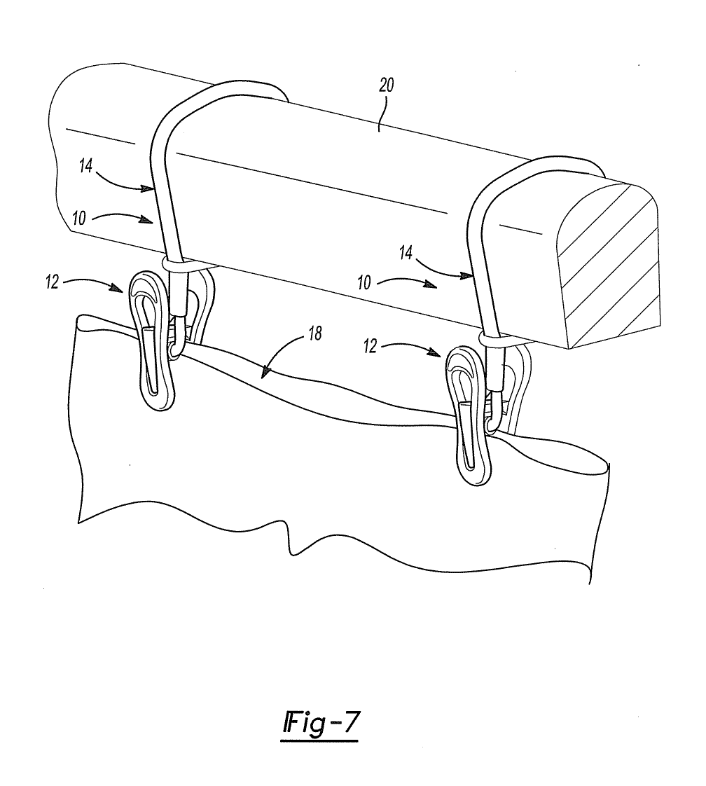

First end portion 72 of cord unit 14 is separated from closed loop 16 via a closure member, such as a bracket 74, that is subsequently enclosed with a shrink wrap logo cover 76. Bracket 74 is positioned to maintain engagement of first end portion 72 within arcuate recess 71 of housing 70 and inhibit unintended disassembly of cord unit 14 from clip unit 12. The length of closed loop 16 is selected to permit resilient cord material 78 to be used to releasably attach cord unit 14 to any available support structure. FIG. 7 illustrates an arrangement where closed loop 16 surrounds deck rail 20 with clip units 12 passing therethrough to releasably fasten article 18 thereto. The specific length of loop 16 can be varied to provide portable hanging devices 10 of variable sizes for use in different places, environments and applications. Additionally, it is possible to expand the cord length. As illustrated in phantom in FIG. 6, the cord is discontinuous and includes fasteners at each end. The fasteners enable the ends to slide on the respective attached cord enabling length adjustment of the cord unit.

During assembly of hanger clip assembly 10, clip unit 12 is initially assembled by installing U-shaped spring bracket 46 on bridge member 38 such that its resilient legs 60, 62 exert a biasing force on clamp members 34, 36 to establish the normally closed position. Next, end portion 72 of closed loop 16 is disposed within recess 70 and bracket 745 is secured thereon to prevent removal of cord unit 14 from clip unit 12. Cover 76 is installed over bracket 74 to provide an aesthetic appearance.

As noted, portable hanger clip assembly 10 is well suited for use in suspending an article from any support structure. One anticipated use is to suspend wet clothes from a support structure (i.e., chair, rail, tree, balcony, curtain rod, door handle, etc. to facilitate air drying.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A clip hanger assembly, comprising:
a clip unit having a clamp assembly and a biasing member, said clamp assembly including a pair of complementary clamp members that are interconnected to a transverse bridge member by a pair of living hinges, said biasing member mounted over said bridge member and configured to apply a biasing force on said clamp members to cause clamp end portions of said clamp members to be located in a closed position, whereby an inward force applied to handle end portions of said clamp members in opposition to the biasing force applied by said biasing member by said biasing member to said clamp members causing said clamp end portions to be located in an open positions; and
a cord unit including a closed loop of resilient cord material having a first end secured to said bridge member, and a closure member separating said first end from a second end that is configured to be releasably attached to a support structure.

2. The clip hanger assembly of claim 1, wherein said bridge member is integrally formed with said clamp members with said living hinges permitting pivotal movement of said clamp members relative to said bridge member.

3. The clip hanger assembly of claim 1 wherein opening are formed in each end of said clamp members between their handle end portions and said bridge member.

4. The clip hanger assembly of claim 1 wherein said living hinges attach to an intermediate portion of said clamp members that are located between their handle end portions and their clamp end portions.

5. The clip hanger assembly of claim 4 wherein said biasing member is a C-shaped spring bracket having a pair of legs interconnected by a transverse flange, wherein said transverse flange is disposed over a top surface of said bridge member such that said legs of said spring bracket engage and apply an inwardly directed biasing force on said intermediate portions of said clamp members.

6. The clip hanger assembly of claim 1 wherein a cylindrical housing having an arcuate recess extends from a bottom surface of said bridge member, and wherein said first end portion of said cord is disposed within said arcuate recess.

7. The clip hanger assembly of claim 6 wherein said closure member is disposed above said biasing member so as to retain said first end of said cord within said arcuate recess.

8. The clip hanger of claim 7 wherein said living hinges attach to an intermediate portion of said clamp members that are located between their handle end portions and their clamp end portions.

9. The clip hanger of claim 8 wherein said biasing member is a C-shaped spring bracket having a pair of legs interconnected by a transverse flange, wherein said transverse flange is disposed over a top surface of said bridge member such that said legs of said spring bracket engage and apply an inwardly directed biasing force on said intermediate portions of said clamp members.
